(19) United States
(12) Patent Application Publication
(10) Pub. No.: US 2023/0100128 A1
(43) Pub. Date: Mar. 30, 2023

(54) ACCELERATING AN INVERSE DESIGN PROCESS USING LEARNED MAPPINGS BETWEEN RESOLUTION LEVELS

(71) Applicant: X Development LLC, Mountain View, CA (US)

(72) Inventors: Ian Alexander Durant Williamson, Palo Alto, CA (US); Martin Schubert, Mountain View, CA (US); Alfred Ka Chun Cheung, Belmont, CA (US)

(21) Appl. No.: 17/486,514

(22) Filed: Sep. 27, 2021

(51) Int. Cl. G06F 30/23; G06F 30/27; G06T 3/40; G06T 17/20; G06N 20/00

(52) U.S. Cl. CPC G06F 30/23; G06F 30/27; G06T 3/40; G06T 17/20; G06N 20/00; G06F 2119/02

(57) ABSTRACT

A computer-implemented method of creating a design for a physical device using an inverse design process is provided. A computing system receives a proposed design. The computing system conducts an operational simulation based on the proposed design at a first resolution to generate a calculated performance result. The computing system provides the calculated performance result to a machine learning model to generate a predicted performance result of an operational simulation based on the proposed design at a second resolution, where the second resolution is higher than the first resolution. The computing system updates the proposed design based on the predicted performance result.

### TECHNICAL FIELD

This disclosure relates generally to inverse design of physical devices, and in particular but not exclusively, relates to inverse design of photonic devices including but not limited to optical multiplexers and demultiplexers.

### BACKGROUND

Fiber-optic communication is typically employed to transmit information from one place to another via light that has been modulated to carry the information. For example, many telecommunication companies use optical fiber to transmit telephone signals, internet communication, and cable television signals. But the cost of deploying optical fibers for fiber-optic communication may be prohibitive. As such, techniques have been developed to more efficiently use the bandwidth available within a single optical fiber. Wavelength-division multiplexing is one such technique that bundles multiple optical carrier signals onto a single optical fiber using different wavelengths.

### BRIEF SUMMARY

In some embodiments, a computer-readable medium is provided. The computer-readable medium has logic stored thereon that, in response to execution by one or more processors of a computing system, cause the computing system to perform actions for creating a design for a physical device using an inverse design process. The actions include receiving, by the computing system, a proposed design; conducting, by the computing system, an operational simulation based on the proposed design at a first resolution to generate a calculated performance result; providing, by the computing system, the calculated performance result to a machine learning model to generate a predicted performance result of an operational simulation based on the proposed design at a second resolution, where the second resolution is higher than the first resolution; and updating, by the computing system, the proposed design based on the predicted performance result.

In some embodiments, a computer-implemented method of creating a design for a physical device using an inverse design process is provided. A computing system receives a proposed design. The computing system conducts an operational simulation based on the proposed design at a first resolution to generate a calculated performance result. The computing system provides the calculated performance result to a machine learning model to generate a predicted performance result of an operational simulation based on the proposed design at a second resolution, where the second resolution is higher than the first resolution. The computing system updates the proposed design based on the predicted performance result.

### BRIEF DESCRIPTION OF THE SEVERAL VIEWS OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described. To easily identify the discussion of any particular element or act, the most significant digit or digits in a reference number refer to the figure number in which that element is first introduced.

FIG. 1A illustrates a demonstrative simulated environment describing a photonic integrated circuit, in accordance with an embodiment of the present disclosure.

FIG. 1B illustrates an example operational simulation of a photonic integrated circuit, in accordance with an embodiment of the present disclosure.

FIG. 1C illustrates an example adjoint simulation within the simulated environment by backpropagating a loss value, in accordance with an embodiment of the present disclosure.

FIG. 2 is a block diagram that illustrates a simplified view of a non-limiting example embodiment of an inverse design process according to various aspects of the present disclosure.

FIG. 3 is a block diagram that illustrates a simplified view of a non-limiting example embodiment of an improved inverse design process according to various aspects of the present disclosure.

FIG. 4 is a block diagram that illustrates a non-limiting example embodiment of a system according to various aspects of the present disclosure.

FIG. 5 is a flowchart that illustrates a non-limiting example embodiment of a method of training a machine learning model to predict full-resolution performance results based on reduced-resolution simulations according to various aspects of the present disclosure.

FIG. 6 is a flowchart that illustrates a non-limiting example embodiment of a method of using a machine learning model to accelerate an inverse design process for a physical device according to various aspects of the present disclosure.

### DETAILED DESCRIPTION

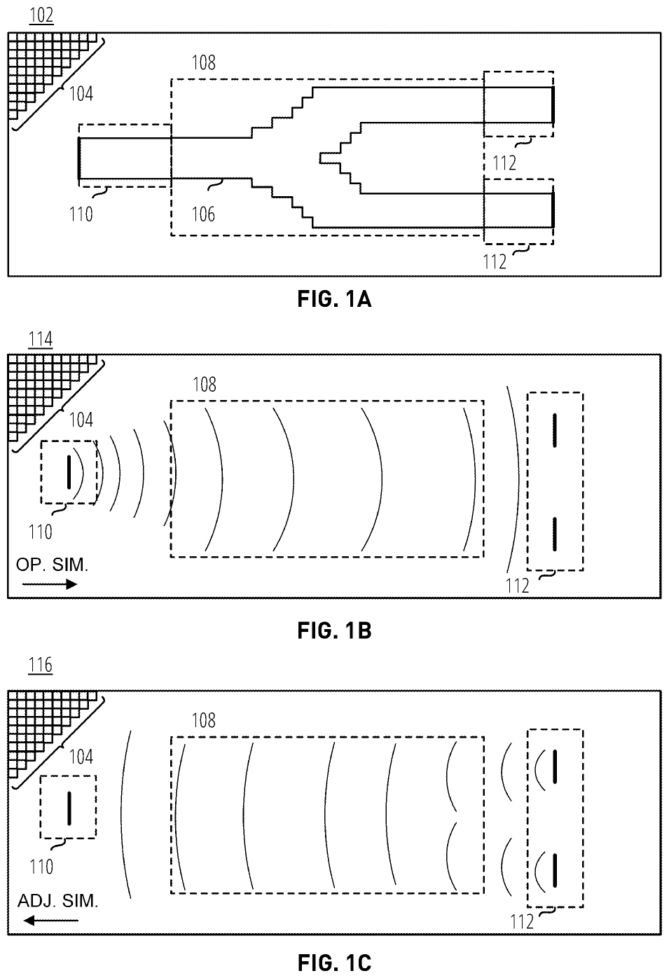

FIG. 1A-FIG. 1C respectively illustrate an initial set up of a simulated environment describing a photonic device, performing an operational simulation of the photonic device in response to an excitation source within a simulated environment, and performing an adjoint simulation of the photonic device within a simulated environment. As illustrated in FIG. 1A-FIG. 1C, simulated environment is represented in two-dimensions. However, it is appreciated that other dimensionality (e.g., 3-dimensional space) may also be used to describe simulated environment and the photonic device. In some embodiments, optimization of structural parameters of the photonic device illustrated in FIG. 1A-FIG. 1C may be achieved via an inverse design process including, inter alia, simulations (e.g., operational simulations and adjoint simulations) that utilize a finite-difference time-domain (FDTD) method, a finite-difference frequency-domain (FDFD) method, or other computational EM methods to model the field response (e.g., electric and magnetic field) to an excitation source.

FIG. 1A illustrates a demonstrative simulated environment 102 describing a photonic integrated circuit (i.e., a photonic device such as a waveguide, demultiplexer, and the like), in accordance with an embodiment of the present disclosure. More specifically, in response to receiving an initial description of a photonic device defined by one or more structural parameters (e.g., an input design), a system configures a simulated environment 102 to be representative of the photonic device. As illustrated, the simulated environment 102 (and subsequently the photonic device) is described by a plurality of segments 104, which represent individual elements (i.e., discretized) of the two-dimensional (or other dimensionality) space. Each of the segments 104 is illustrated as two-dimensional squares; however, it is appreciated that the segments may be represented as cubes or other shapes in three-dimensional space. It is appreciated that the specific shape and dimensionality of the plurality of segments 104 may be adjusted depending on the simulated environment 102 and photonic device (or other physical device) being simulated. It is further noted that only a portion of the plurality of segments 104 are illustrated to avoid obscuring other aspects of the simulated environment 102.

Each of the plurality of segments 104 may be associated with a structural value, a field value, and a source value. Collectively, the structural values of the simulated environment 102 describe the structural parameters of the photonic device. In one embodiment, the structural values may correspond to a relative permittivity, permeability, and/or refractive index that collectively describe structural (i.e., material) boundaries or interfaces of the photonic device. For example, an interface 106 is representative of where relative permittivity changes within the simulated environment 102 and may define a boundary of the photonic device where a first material meets or otherwise interfaces with a second material. The field value describes the field (or loss) response that is calculated (e.g., via Maxwell's equations) in response to an excitation source described by the source value. The field response, for example, may correspond to a vector describing the electric and/or magnetic fields (e.g., in one or more orthogonal directions) at a particular time step for each of the plurality of segments 104. Thus, the field response may be based, at least in part, on the structural parameters of the photonic device and the excitation source.

In the illustrated embodiment, the photonic device corresponds to an optical demultiplexer having a design region 108, in which structural parameters of the physical device may be updated or otherwise revised. More specifically, through an inverse design process, iterative gradient-based optimization of a loss metric determined from a loss function is performed to generate a design of the photonic device that functionally causes a multi-channel optical signal to be demultiplexed and guided from input port 110 to a corresponding one of the output ports 112. Thus, input port 110 of the photonic device corresponds to a location of an excitation source to provide an output (e.g., a Gaussian pulse, a wave, a waveguide mode response, and the like). The output of the excitation source interacts with the photonic device based on the structural parameters (e.g., an electromagnetic wave corresponding to the excitation source may be perturbed, retransmitted, attenuated, refracted, reflected, diffracted, scattered, absorbed, dispersed, amplified, or otherwise as the wave propagates through the photonic device within simulated environment 102). In other words, the excitation source may cause the field response of the photonic device to change, which is dependent on the underlying physics governing the physical domain and the structural parameters of the photonic device. The excitation source originates or is otherwise proximate to input port 110 and is positioned to propagate (or otherwise influence the field values of the plurality of segment) through the design region 108 towards output ports 112 of the photonic device. In the illustrated embodiment, the input port 110 and output ports 112 are positioned outside of the design region 108. In other words, in the illustrated embodiment, only a portion of the structural parameters of the photonic device is optimizable.

However, in other embodiments, the entirety of the photonic device may be placed within the design region 108 such that the structural parameters may represent any portion or the entirety of the design of the photonic device. The electric and magnetic fields within the simulated environment 102 (and subsequently the photonic device) may change (e.g., represented by field values of the individual segment that collectively correspond to the field response of the simulated environment) in response to the excitation source. The output ports 112 of the optical demultiplexer may be used for determining a performance metric of the photonic device in response to the excitation source (e.g., power transmission from input port 110 to a specific one of the output ports 112). The initial description of the photonic device, including initial structural parameters, excitation source, performance parameters or metrics, and other parameters describing the photonic device, may be received by a system and used to configure the simulated environment 102 for performing a first-principles based simulation of the photonic device. These specific values and parameters may be defined directly by a user, indirectly (e.g., by a system culling pre-determined values stored in a memory, local storage, or remote resources), or a combination thereof.

FIG. 1B illustrates an operational simulation of the photonic device in response to an excitation source within simulated environment 114, in accordance with various aspects of the present disclosure. In the illustrated embodiment, the photonic device is an optical demultiplexer structured to optically separate each of a plurality of distinct wavelength channels included in a multi-channel optical signal received at input port 110 and respectively guide each of the plurality of distinct wavelength channels to a corresponding one of the plurality of output ports 112. The excitation source may be selected (randomly or otherwise) from the plurality of distinct wavelength channels and originates at input port 110 having a specified spatial, phase, and/or temporal profile. The operational simulation occurs over a plurality of time steps, including the illustrated time step. When performing the operational simulation, changes to the field response (e.g., the field value) for each of the plurality of segments 104 are incrementally updated in response to the excitation source over the plurality of time steps. The changes in the field response at a particular time step are based, at least in part, on the structural parameters, the excitation source, and the field response of the simulated environment 116 at the immediately prior time step included in the plurality of time steps. Similarly, in some embodiments the source value of the plurality of segments 104 is updated (e.g., based on the spatial profile and/or temporal profile describing the excitation source). It is appreciated that the operational simulation is incremental and that the field values (and source values) of the simulated environment 116 are updated incrementally at each time step as time moves forward for each of the plurality of time steps during the operational simulation. It is further noted that in some embodiments, the update is an iterative process and that the update of each field and source value is based, at least in part, on the previous update of each field and source value.

Once the operational simulation reaches a steady state (e.g., changes to the field values in response to the excitation source substantially stabilize or reduce to negligible values) or otherwise concludes, one or more performance metrics may be determined. In some embodiments, the performance metric corresponds to the power transmission at a corresponding one of the output ports 112 mapped to the distinct wavelength channel being simulated by the excitation source. In other words, in some embodiments, the performance metric represents power (at one or more frequencies of interest) in the target mode shape at the specific locations of the output ports 112. A loss value or metric of the input design (e.g., the initial design and/or any refined design in which the structural parameters have been updated) based, at least in part, on the performance metric may be determined via a loss function. The loss metric, in conjunction with an adjoint simulation, may be utilized to determine a structural gradient (e.g., influence of structural parameters on loss metric) for updating or otherwise revising the structural parameters to reduce the loss metric (i.e. increase the performance metric). It is noted that the loss metric may be further based on a fabrication loss value that is utilized to enforce a minimum feature size or other fabricability constraints of the photonic device to promote fabricability of the device.

FIG. 1C illustrates an example adjoint simulation within simulated environment 116 by backpropagating a loss metric, in accordance with various aspects of the present disclosure. More specifically, the adjoint simulation is a time-backwards simulation in which a loss metric is treated as an excitation source that interacts with the photonic device and causes a loss response. In other words, an adjoint (or virtual source) based on the loss metric is placed at the output region (e.g., output ports 112) or other location that corresponds to a location used when determining the performance metric. The adjoint source(s) is then treated as a physical stimuli or an excitation source during the adjoint simulation. A loss response of the simulated environment 116 is computed for each of the plurality of time steps (e.g., backwards in time) in response to the adjoint source. The loss response collectively refers to loss values of the plurality of segments that are incrementally updated in response to the adjoint source over the plurality of time steps. The change in loss response based on the loss metric may correspond to a loss gradient, which is indicative of how changes in the field response of the physical device influence the loss metric. The loss gradient and the field gradient may be combined in the appropriate way to determine a structural gradient of the photonic device/simulated environment (e.g., how changes in the structural parameters of the photonic device within the simulated environment influence the loss metric). Once the structural gradient of a particular cycle (e.g., operational and adjoint simulation) is known, the structural parameters may be updated to reduce the loss metric and generate a revised description or design of the photonic device.

In some embodiments, iterative cycles of performing the operational simulation, and adjoint simulation, determining the structural gradient, and updating the structural parameters to reduce the loss metric are performed successively as part of an inverse design process that utilizes iterative gradient-based optimization. An optimization scheme such as gradient descent may be utilized to determine specific amounts or degrees of changes to the structural parameters of the photonic device to incrementally reduce the loss metric. More specifically, after each cycle the structural parameters are updated (e.g., optimized) to reduce the loss metric. The operational simulation, adjoint simulation, and updating the structural parameters are iteratively repeated until the loss metric substantially converges or is otherwise below or within a threshold value or range such that the photonic device provides the desired performance while maintaining fabricability.

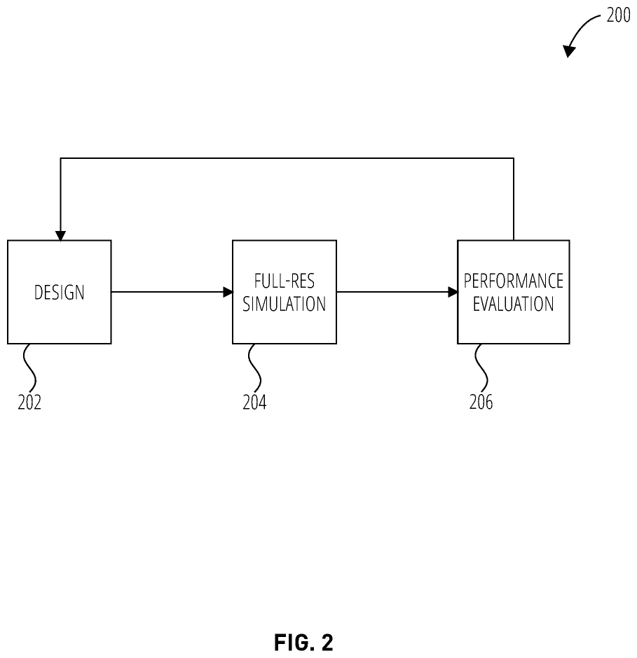

FIG. 2 is a block diagram that illustrates a simplified view of a non-limiting example embodiment of an inverse design process according to various aspects of the present disclosure. In the process 200, a design 202 is obtained, a full-resolution simulation 204 (including an operational simulation) is performed, a performance evaluation 206 is conducted on the result of the full-resolution simulation 204, and a result of the performance evaluation 206 is used to update the design 202. This loop—from updated design 202, to full-resolution simulation 204, to performance evaluation 206, and back to an updated design 202—is performed many times during the process 200 before the design 202 converges to a desired result (or another stopping condition is reached).

Since this loop is repeated many times during the process 200, any savings in computational time during any individual step will be compounded through repetition to greatly reduce the time for the process 200 overall. For example, the computational time used for the full-resolution simulation 204 may dominate the length of the overall process 200, particularly when the segments 104 of the design 202 are numerous and/or each time step of the operational simulation is short.

The length of time for the overall process 200 could be shortened by simply reducing the resolution of the full-resolution simulation 204. In other words, the size of the segments 104 simulated in the operational simulation may be increased, the length of each time step may be increased, a result may not be computed for every time step, or combinations such techniques, in order to reduce the number of computations required for each simulation. However, increasing the size of the segments 104 in the operational simulation, lengthening each time step, or skipping evaluation of certain time steps would lead to a reduction in accuracy of the operational simulation, and may result in a failure of the updated design 202 to successfully converge to a highly performant design. What is desired are techniques that can be used to increase the speed of computation of the process 200 by performing reduced-resolution simulations while not unduly affecting the accuracy of each simulation, thus allowing the design 202 to converge to a highly performant result.

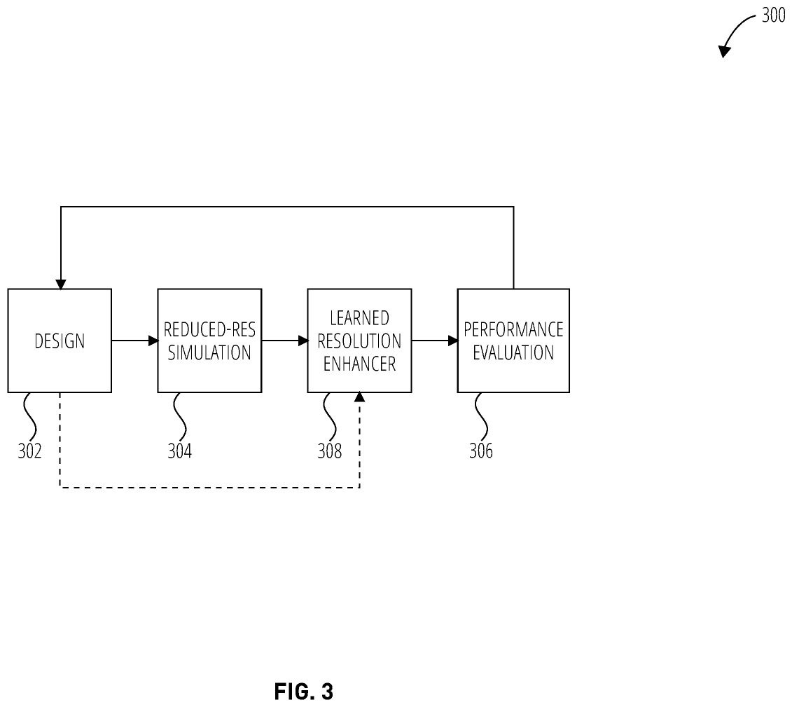

FIG. 3 is a block diagram that illustrates a simplified view of a non-limiting example embodiment of an improved inverse design process according to various aspects of the present disclosure. Similar to the process 200 illustrated in FIG. 2, the process 300 illustrated in FIG. 3 starts with obtaining a design 302. However, instead of proceeding to a full-resolution simulation 204, the process 300 instead performs a reduced-resolution simulation 304. The reduced-resolution simulation 304 may use a technique that matches a technique used in the full-resolution simulation 204 (e.g., may be a FDTD, FDFD, or other type of simulation), but may have some aspect that is not as detailed as the full-resolution simulation 204.

In some embodiments, the full-resolution simulation 204 may use a first spatial resolution, and the reduced-resolution simulation 304 may use a coarser second spatial resolution. For example, the full-resolution simulation 204 may divide the design region 108 into segments 104 such that there are 1000 segments in a horizontal direction and 1000 segments in a vertical direction. In comparison, the reduced-resolution simulation 304 may divide the same design region 108 into segments 104 such that there are 250 segments in a horizontal direction and 250 segments in a vertical direction, thus drastically reducing the number of segments 104 to be analyzed. Typically, the first spatial resolution and the second spatial resolution are within a range of 1/10th of a wavelength to 1/40th of a wavelength, though resolutions outside of this range may also be used.

In some embodiments, the full-resolution simulation 204 may use a first temporal resolution, and the reduced-resolution simulation 304 may use a coarser second temporal resolution. For example, the full-resolution simulation 204 may use time steps in which an impulse travels half a segment, while in comparison, the reduced-resolution simulation 304 may use time steps in which an impulse travels an entire segment. As another example, the full-resolution simulation 204 may update field values every time step, while the reduced-resolution simulation 304 may update field values once for multiple time steps, such as every second time step, every third time step, or at some other interval.

In some embodiments, the reduced-resolution simulation 304 may adjust both a spatial resolution and a temporal resolution of the full-resolution simulation 204. For example, the length of the time step of the full-resolution simulation 204 may be specified such that an impulse will propagate the length of a single segment during the time step. As the size of the segments is increased in the reduced-resolution simulation 304, the length of the time step may also be increased such that the impulse will propagate the length of the single larger segment. The spatial resolution and the temporal resolution may be adjusted together in order to ensure that the Courant condition is satisfied (i.e., the numerical speed of the wave from time step to time step does not exceed the physical wave speed).

After obtaining a result from the reduced-resolution simulation 304, the process 300 provides the result to a learned resolution enhancer 308. The learned resolution enhancer 308 takes some result of the reduced-resolution simulation 304, such as s-parameter values and/or a scalar measure of performance of the simulated physical device, and uses a machine learning model to predict a result that would have been generated using the full-resolution simulation 204 of the same design 302. In some embodiments, the original design 302 is also provided to the learned resolution enhancer 308 (as indicated by the dashed link between the design 302 and the learned resolution enhancer 308). The performance evaluation 306 is then conducted on the result predicted by the learned resolution enhancer 308, and this performance evaluation 306 is then used to update the design 302. As with the process 200, the loop illustrated in process 300 is repeated multiple times until the design 302 converges to a desired result (or another stopping condition is reached).

By using a reduced-resolution simulation 304 instead of a full-resolution simulation 204, the process 300 is able to greatly reduce the amount of computation time needed for the stopping condition to be reached. Further, by using the learned resolution enhancer 308, the process 300 is able to avoid inaccuracies and inefficiencies that may be included in the results by simply reducing the resolution without such enhancement. Further description of the reduced-resolution simulation 304, the learned resolution enhancer 308, and the overall process 300 is provided below.

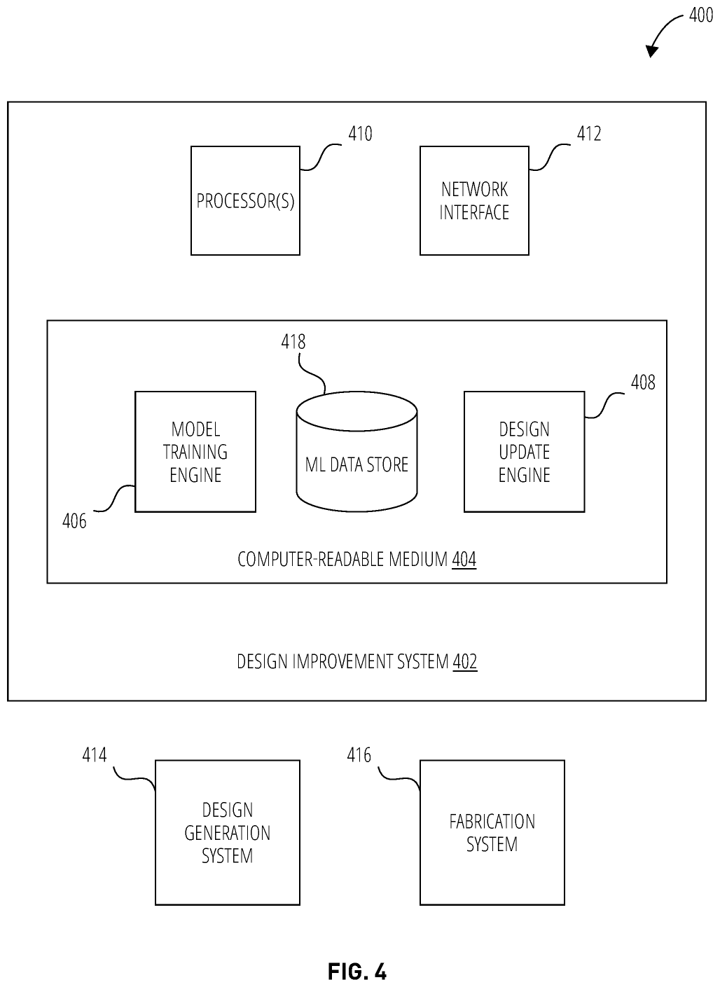

FIG. 4 is a block diagram that illustrates a non-limiting example embodiment of a system according to various aspects of the present disclosure. Overall, the illustrated embodiment of the system 400 is configured to generate proposed designs and to fabricate physical devices based on the proposed designs.

As shown, the system 400 includes a design generation system 414, a fabrication system 416, and a design improvement system 402. Communication between the design generation system 414, the design improvement system 402, and the fabrication system 416 may occur via a network (not pictured), via exchange of a removable computer-readable medium (not pictured), or via any other suitable technique. Though the design generation system 414, fabrication system 416, and design improvement system 402 are illustrated as separate systems, in some embodiments, some portions of these systems may be combined. As one non-limiting example, the design generation system 414 and the design improvement system 402 may be combined in a single system. Also, in some embodiments, systems illustrated in FIG. 4 as a single system may be broken into multiple systems.

In some embodiments, the design generation system 414 may include one or more computing devices that are configured to generate designs that achieve a desired result. For example, the design generation system 414 may use forward simulation and backpropagation techniques to generate a design for an optoelectronic device (or any other type of physical device) that has desired characteristics. This is a non-limiting example only, and any other technique, including but not limited to manual design, may be used by the design generation system 414 to create proposed designs.

In some embodiments, the fabrication system 416 may be any suitable system for fabricating a design. In some embodiments, the fabrication system 416 may be a photolithography system or an additive manufacturing system. In some embodiments, the fabrication system 416 may have characteristics that include a minimum feature size, a minimum feature shape, and/or other constraints that help define the designs that the fabrication system 416 is capable of fabricating.

In some embodiments, the design improvement system 402 may be any suitable computing device or collection of computing devices configured to provide the described functionality. In some embodiments, the design improvement system 402 may be a server computing device, a desktop computing device, a laptop computing device, a mobile computing device, a tablet computing device, or one or more computing devices of a cloud computing system.

As shown, the design improvement system 402 includes one or more processors 410, a network interface 412, and a computer-readable medium 404. In some embodiments, the one or more processors 410 may include a plurality of processors and/or a plurality of processing cores in order to provide a large amount of computing power. In some embodiments, the processors may include any suitable type of general-purpose computer processor. In some embodiments, the processors may include one or more special-purpose computer processors or AI accelerators optimized for specific computing tasks, including but not limited to graphical processing units (GPUs), vision processing units (VPTs), and tensor processing units (TPUs).

In some embodiments, the network interface 412 may be configured to communicate with the design generation system 414 and/or the fabrication system 416 via any suitable type of wired network (including but not limited to Ethernet, FireWire, and USB), wireless network (including but not limited to 2G, 3G, 4G, 5G, LTE, Wi-Fi, WiMAX, and Bluetooth), or combinations thereof. In some embodiments, instead of a network interface 412, the design improvement system 402 may be configured to communicate with the design generation system 414 and/or the fabrication system 416 via transfer of a removable computer-readable medium (not shown).

As shown, the computer-readable medium 404 has stored thereon logic that, in response to execution by the one or more processors 410, cause the design improvement system 402 to provide a model training engine 406 and a design update engine 408. The illustrated computer-readable medium 404 is also shown as storing a machine learning data store (ML data store 418).

As used herein, “engine” refers to logic embodied in hardware or software instructions, which can be written in a programming language, such as C, C++, C#, COBOL, JAVA™, PHP, Perl, HTML, CSS, JavaScript, VBScript, ASPX, Go, Python, and/or the like. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

In some embodiments, the design update engine 408 is configured to perform an inverse design process of a physical device, including performing operational simulations and adjoint simulations of proposed designs. In some embodiments, the design update engine 408 includes one or more configuration settings that may change a resolution of the operational simulation and/or the adjoint simulation in order to trade increased computational speed for decreased computational accuracy. In some embodiments, the model training engine 406 is configured to create training pairs of full-resolution simulation results and reduced-resolution simulation results generated by the design update engine 408, and to store them in the ML data store 418. The model training engine 406 is also configured to train a machine learning model using the training pairs stored in the ML data store 418 to predict full-resolution simulation results based on reduced-resolution simulation results, and to store the trained machine learning model in the ML data store 418.

In some embodiments, the design update engine 408 is also configured to use the trained machine learning model from the ML data store 418 to predict full-resolution simulation results based on reduced-resolution simulation results. By doing so, the design update engine 408 can achieve the increased computational speed offered by performing reduced resolution simulations without suffering significantly decreased computational accuracy. Further description of these techniques is provided below.

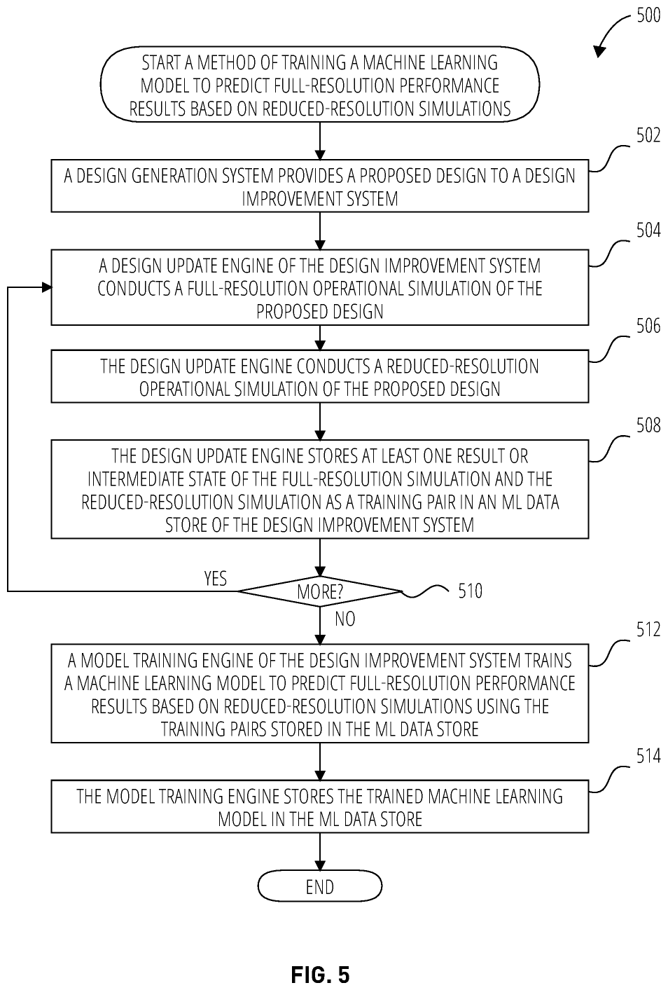

FIG. 5 is a flowchart that illustrates a non-limiting example embodiment of a method of training a machine learning model to predict full-resolution performance results based on reduced-resolution simulations according to various aspects of the present disclosure. In the method 500, a machine learning model is trained that can predict a result of a full-resolution simulation based on a result of a reduced-resolution simulation.

From a start block, the method 500 proceeds to block 502, where a design generation system 414 provides a proposed design to a design improvement system 402. In some embodiments, the proposed design may include specifications of physical structures for the physical device generated randomly, generated using a naïve optimization technique, generated manually, or generated using any other suitable technique. In some embodiments, the proposed design may include a linear function that represents one or more desired characteristics for the resulting physical device instead of specifying specifications of physical structures.

At block 504, a design update engine 408 of the design improvement system 402 conducts a full-resolution operational simulation of the proposed design. As discussed above, the full-resolution operational simulation may use a first spatial resolution and a first temporal resolution, and the operational simulation may be an FDTD simulation, an FDFD simulation, or any other suitable type of simulation. In some embodiments, the result of the full-resolution operational simulation includes s-parameters at one or more time steps. In some embodiments, the result of the full-resolution operational simulation includes field distribution(s) within the proposed design at one or more time steps. In some embodiments, the result of the full-resolution operational simulation includes a scalar performance metric, such as a comparison of a simulated output of the simulated proposed design to a desired performance.

At block 506, the design update engine 408 conducts a reduced-resolution operational simulation of the proposed design. The reduced-resolution operational simulation uses a matching simulation technique to the technique used in the full-resolution operational simulation and, as discussed above, uses a second spatial resolution and a second temporal resolution, one or both of which may be coarser than the first spatial resolution and the first temporal resolution used by the full-resolution operational simulation. The result of the reduced-resolution operational simulation corresponds to the result of the full-resolution operational simulation, and so may include s-parameters at one or more time steps, a scalar performance metric, or both.

At block 508, the design update engine 408 stores at least one result or intermediate state of the full-resolution simulation and the reduced-resolution simulation as a training pair in an ML data store 418 of the design improvement system 402. An intermediate state may be s-parameters, field values, or other values from a time step other than a final step, and a result may be the s-parameters and/or scalar performance metrics described above.

The method 500 then proceeds to decision block 510, where a determination is made regarding whether more training pairs are desired. Each training pair associates a result or intermediate state of the full-resolution simulation with the corresponding result or intermediate state of the reduced-resolution simulation. To improve the predictive capabilities of the machine learning model, it may be desirable to have a larger amount of training data, and so a large number of training pairs may be desired. The determination of whether more training pairs are desired may be based on any suitable criterion, including but not limited to whether a threshold number of training pairs have been generated, whether a set of proposed designs have all been processed, whether a desired range of settings for the spatial resolutions and temporal resolutions have been covered, and other suitable criterion.

If more training pairs are desired, then the result of decision block 510 is YES, and the method 500 returns to block 504 to generate another training pair. Additional training pairs may be generated by altering the parameters of the method 500 in any suitable way. As one non-limiting example, different structural parameters or performance goals may be provided to block 504 as part of a different proposed design to be simulated. As another non-limiting example, different values may be used for the temporal resolutions and/or the spatial resolutions. As yet another non-limiting example, an adjoint simulation may be conducted to determine a structural gradient and to update the proposed design, and the updated proposed design may be used at block 504 to generate the next training pair.

Otherwise, if no more training pairs are desired, then the result of decision block 510 is NO, and the method 500 proceeds to block 512. At block 512, a model training engine 406 of the design improvement system 402 trains a machine learning model to predict full-resolution performance results based on reduced-resolution simulations using the training pairs stored in the ML data store 418. The results stored in the training pair for the full-resolution simulation is used as the ground truth information, ad the results stored in the training pair for the reduced-resolution simulation is used as the input for the machine learning model. Any suitable architecture may be used for the machine learning model, including but not limited to a neural network, a convolutional neural network, a neural network with some convolutional layers and some fully connected layers, and an ensemble of neural networks. Any suitable technique may be used to train the machine learning model, including but not limited to gradient descent, stochastic gradient descent, an adaptive gradient algorithm (AdaGrad), root mean square propagation (RMSProp), and an Adam optimizer.

At block 514, the model training engine 406 stores the trained machine learning model in the ML data store 418. In some embodiments, the training pairs used to train the machine learning model may be limited to a given dimensionality for the proposed design, a given first temporal resolution and first spatial resolution, and/or a given second temporal resolution and second spatial resolution. In such embodiments, the machine learning model may be stored in the ML data store 418 along with an indication of the corresponding dimensionality and resolutions for which the machine learning model is appropriate.

The method 500 then proceeds to an end block and terminates. Though the method 500 is described as training a machine learning model to predict a result of a full-resolution operational simulation, in some embodiments, a machine learning model may be trained to predict a result of a full-resolution adjoint simulation based on a result of a reduced-resolution adjoint simulation.

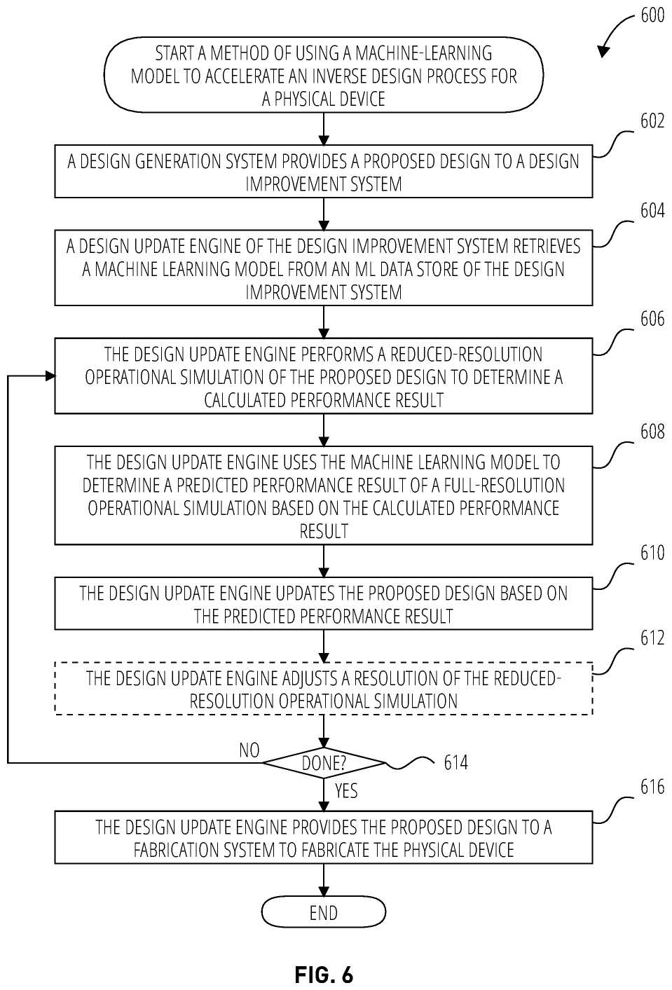

FIG. 6 is a flowchart that illustrates a non-limiting example embodiment of a method of using a machine learning model to accelerate an inverse design process for a physical device according to various aspects of the present disclosure. In the method 600, an inverse design process is conducted in which a reduced-resolution simulation replaces a full-resolution simulation in order to increase processing speed, and a machine learning model trained using a technique such as the method 500 described above is used to predict the result of the full-resolution simulation based on the result of the reduced-resolution simulation in order to avoid a reduction in quality of the design produced by the method 600.

From a start block, the method 600 proceeds to block 602, where a design generation system 414 provides a proposed design to a design improvement system 402. As at block 502, in some embodiments, the proposed design may include specifications of physical structures for the physical device generated randomly, generated using a naïve optimization technique, generated manually, or generated using any other suitable technique. In some embodiments, the proposed design may include a linear function that represents one or more desired characteristics for the resulting physical device instead of specifying specifications of physical structures.

At block 604, a design update engine 408 of the design improvement system 402 retrieves a machine learning model from an ML data store 418 of the design improvement system 402. Typically, a machine learning model is retrieved from the ML data store 418 that was trained using parameters that match parameters of the proposed design, the full-resolution simulation, and/or the reduced-resolution simulation. For example, in some embodiments, the machine learning model may be retrieved based on a size, a dimensionality, a spatial resolution, a temporal resolution, or any other aspect of the proposed design and/or the full-resolution simulation, and/or a size, a dimensionality, a spatial resolution, a temporal resolution, or any other aspect of the intended reduced-resolution simulation.

At block 606, the design update engine 408 performs a reduced-resolution operational simulation of the proposed design to determine a calculated performance result, and at block 608, the design update engine 408 uses the machine learning model to determine a predicted performance result of a full-resolution operational simulation based on the calculated performance result. If the machine learning model was trained to predict full-resolution s-parameters or field values based on reduced-resolution s-parameters or field values, then the method 600 may use the predicted full-resolution s-parameters or field values to generate a full-resolution scalar performance metric for the operational simulation at block 608. If the machine learning model was trained to directly predict the full-resolution scalar performance metric from the reduced-resolution operational simulation, the method 600 may directly predict that metric at block 608.

At block 610, the design update engine 408 updates the proposed design based on the predicted performance result. In some embodiments, a structural gradient may be determined based on the predicted performance result, and the proposed design may be updated using the structural gradient. In some embodiments, an adjoint simulation may be conducted as part of determining the structural gradient and/or updating the proposed design.

Even though the machine learning model can help to improve the accuracy of results of reduced-resolution simulations, the predicted results will likely still be different than a result of a full-resolution simulation. Accordingly, as the method 600 iterates over the optimization loop from block 606 to optional decision block 614, it may be desired to adjust the trade-off of speed for accuracy so that a highly performant final proposed design can be obtained. Hence, at optional block 612, the design update engine 408 adjusts a resolution of the reduced-resolution operational simulation. The design update engine 408 may increase the spatial resolution and/or temporal resolution of the reduced-resolution operational simulation to be closer to that of the full-resolution operational simulation, eventually reaching the same resolution as the full-resolution operational simulation. If a new resolution for the reduced-resolution operational simulation is selected, then the design update engine 408 may also retrieve a new machine learning model that corresponds to the new resolution, as discussed above in block 604. Optional block 612 is illustrated as optional because in some embodiments, the resolution of the reduced-resolution simulation may stay constant over the course of the method 600.

The method 600 then proceeds to decision block 614, where a determination is made regarding whether updates to the proposed design are complete. In some embodiments, the determination may be based on whether a predetermined number of iterations of the simulate-predict-update optimization loop have been performed. In some embodiments, the determination may be based on whether a performance metric is achieved by the proposed design. In some embodiments, the determination may be based on whether the performance metric has converged to a stable value.

If the determination at decision block 614 is that updates to the proposed design are not complete, then the result of decision block 614 is NO, and the method 600 returns to block 606 to perform a subsequent iteration of the simulation-prediction-update loop. The simulation-prediction-update loop is similar to the loop illustrated in FIG. 3 and discussed above.

Otherwise, if the determination at decision block 614 is that updates to the proposed design are complete, then the result of decision block 614 is YES, and the method 600 advances to block 616. At block 616, the design update engine 408 provides the proposed design to a fabrication system 416 to fabricate the physical device. In some embodiments, the proposed design may instead be stored for later fabrication.

The method 600 then proceeds to an end block and terminates.

Though the method 600 is described as using a machine learning model to predict a result of a full-resolution operational simulation, in some embodiments, a machine learning model may be used to predict a result of a full-resolution adjoint simulation based on a result of a reduced-resolution adjoint simulation.

In the preceding description, numerous specific details are set forth to provide a thorough understanding of various embodiments of the present disclosure. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The order in which some or all of the blocks appear in each method flowchart should not be deemed limiting. Rather, one of ordinary skill in the art having the benefit of the present disclosure will understand that actions associated with some of the blocks may be executed in a variety of orders not illustrated, or even in parallel.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A computer-readable medium having logic stored thereon that, in response to execution by one or more processors of a computing system, cause the computing system to perform actions for creating a design for a physical device using an inverse design process, the actions comprising:
receiving, by the computing system, a proposed design;
conducting, by the computing system, an operational simulation based on the proposed design at a first resolution to generate a calculated performance result;
providing, by the computing system, the calculated performance result to a machine learning model to generate a predicted performance result of an operational simulation based on the proposed design at a second resolution, wherein the second resolution is higher than the first resolution; and
updating, by the computing system, the proposed design based on the predicted performance result.

2. The computer-readable medium of claim 1, wherein the first resolution is a first spatial resolution and the second resolution is a second spatial resolution.

3. The computer-readable medium of claim 1, wherein the first resolution is a first temporal resolution and the second resolution is a second temporal resolution.

4. The computer-readable medium of claim 3, wherein the first temporal resolution is a first time step length and wherein the second temporal resolution is a second time step length.

5. The computer-readable medium of claim 3, wherein the first temporal resolution is a first time step update interval and the second temporal resolution is a second time step update interval.

6. The computer-readable medium of claim 1, wherein the predicted performance result is a predicted s-parameter of the physical device.

7. The computer-readable medium of claim 1, wherein the predicted performance result is a predicted scalar performance metric.

8. The computer-readable medium of claim 1, wherein the actions further comprise:
repeating the conducting, providing, and updating actions until the predicted performance reaches a threshold performance value.

9. The computer-readable medium of claim 8, wherein the actions further comprise:
increasing the first resolution before at least one repetition of the conducting, providing, and updating actions.

10. The computer-readable medium of claim 1, wherein the actions further comprise transmitting the proposed design to a fabrication system to fabricate the physical device.

11. A computer-implemented method of creating a design for a physical device using an inverse design process, the method comprising:
receiving, by a computing system, a proposed design;
conducting, by the computing system, an operational simulation based on the proposed design at a first resolution to generate a calculated performance result;
providing, by the computing system, the calculated performance result to a machine learning model to generate a predicted performance result of an operational simulation based on the proposed design at a second resolution, wherein the second resolution is higher than the first resolution; and
updating, by the computing system, the proposed design based on the predicted performance result.

12. The method of claim 11, wherein the first resolution is a first spatial resolution and the second resolution is a second spatial resolution.

13. The method of claim 11, wherein the first resolution is a first temporal resolution and the second resolution is a second temporal resolution.

14. The method of claim 13, wherein the first temporal resolution is a first time step length and wherein the second temporal resolution is a second time step length.

15. The method of claim 13, wherein the first temporal resolution is a first time step update interval and the second temporal resolution is a second time step update interval.

16. The method of claim 11, wherein the predicted performance result is a predicted s-parameter of the physical device.

17. The method of claim 11, wherein the predicted performance result is a predicted scalar performance metric.

18. The method of claim 11, further comprising:
repeating the conducting, providing, and updating actions until the predicted performance reaches a threshold performance value.

19. The method of claim 18, further comprising:
increasing the first resolution before at least one repetition of the conducting, providing, and updating actions.

20. The method of claim 11, further comprising transmitting the proposed design to a fabrication system to fabricate the physical device.
